(19) United States
(12) Patent Application Publication
(10) Pub. No.: US 2004/0057126 A1
(43) Pub. Date: Mar. 25, 2004

(54) Bowl sander

(76) Inventor: Michael F. Wilson, St. Charles, MO (US)

Correspondence Address: CHARLES C. MCCLOSKEY, 763 S. NEW BALLAS ROAD STE. 170, ST. LOUIS, MO, 63141, US

(21) Appl. No.: 10/631,658

(22) Filed: Jul. 31, 2003

Related U.S. Application Data
(60) Provisional application No. 60/401,528, filed on Aug. 8, 2002.

(51) Int. Cl. G02B 7/02

(52) U.S. Cl. 359/819

(57) ABSTRACT

A device and method to sand sink bowl flanges has an abrasive, a disk, a motor, a stand, a frame and a separate arm, holders, and a switch. An abrasive coats the disk. The motor rotates the disk in a nearly vertical plane. The motor rests upon the stand and the frame. The frame attaches to a floor and a wall. The arm in front of the frame positions a sink bowl in holders. An operator depresses a foot switch activating the motor, and then advances the arm, placing the flange of the sink bowl upon the rotating disk until smooth.

### CROSS REFERENCE TO RELATED APPLICATIONS

This application is a non-provisional application of and claims priority to provisional application Serial No. 60/401,528, filed on Aug. 8, 2002, the disclosure of which is herein incorporated by reference in its entirety.

### BACKGROUND OF THE INVENTION

1. Field of the Invention

The present invention relates to a bowl sander for use as a sanding machine in connection with composite sink bowls. The bowl sander has particular utility in connection with a substantially vertical rotating disk.

2. Description of the Prior Art

Bowl sanders are desirable to advance a sink bowl into a sander with minimal force applied by a worker. Prior art designs provided a table covered with sandpaper. The conventional design allows a worker to lift a sink bowl, to place it upon a sanding table, and then to move the sink bowl across the table until the flanges of the sink bowl become smooth. Because of the size of a sink bowl, one or more workers often lean over the sanding table posing a safety risk. Prior art designs also provide a sander with an attached table. Using these designs, the worker places a sink bowl upon a table and pushes the sink bowl into the sander at a predetermined angle. Another typical design provides a sander that moves across a fixed workpiece. In summary, prior art requires one or more workers to lean upon a sink bowl over a sanding table in order to sand the flanges of a sink bowl.

The present art overcomes the limitations of the prior art. That is, the art of the present bowl sander allows a worker to position a sink bowl upon a sander without the worker leaning over a sanding table. The present art further allows an arm to bear the weight of a sink bowl.

The difficulty in providing smooth flanges of sink bowls while protecting workers is shown by the operation of a typical device. The present invention overcomes this difficulty. Sink bowls have a large awkward shape with a flange around the sink opening. To attain a smooth sink bowl flange, workers sand the entire flange as a unit. A typical sanding device takes the form of a table covered in strips of sandpaper. Placing a sink bowl upon a typical device and moving the sink bowl, requires one or more workers to lean over the sanding table. For a smooth bowl flange, workers move the sink bowl about the sanding table while simultaneously applying pressure to the sink bowl. A worker risks lifting and bending injuries.

The use of sanding machines is known in the prior art. For example, U.S. Pat. No. 2,294,047 to Pollock discloses a tire-abrading machine. However, the Pollock '047 patent does not pivot a tire about a horizontal axis, and does not fix the position of the motor.

U.S. Pat. No. 4,228,618 to Jensen discloses a rotary disk sander that has a tilting table. However, the Jensen '618 patent does not advance a work piece with an arm, and additionally does not fix the position of the motor.

Similarly, U.S. Pat. No. 4,574,530 to Handler et al. discloses a drill powered abrasive machine that sands workpieces. However, the Handler '530 patent does not advance a work piece into the sander, and cannot operate with an integral motor.

Then, U.S. Pat. No. 1,404,605 to Hansen discloses a surface-grinding machine having a tilting table. However, the Hansen '605 patent does not grasp a workpiece, and cannot advance a workpiece into the sander.

U.S. Pat. No. 4,246,727 to Weissman discloses a device that positions a holder containing a gem. However, the Weissman '727 patent does not have a sander oriented vertically, and cannot grasp a gem at more than one point.

Similarly, U.S. Pat. No. 4,536,992 to Hennenfent et al. discloses a lapping system to shape electronic parts. However, the Hennenfent '992 patent does not have a vertically oriented sander, and cannot operate in the absence of slurry.

Lastly, U.S. Pat. No. 3,631,639 to Day & McCandless discloses a device that grinds valve stems on engines. However, the Day & McCandless '639 patent does not grasp and advance a valve stem into the grinder, and has the additional deficiency of mounting upon a reference point.

While the above-described devices fulfill their respective, particular objectives and requirements, the aforementioned patents do not describe a bowl sander that grasps a sink bowl and advances a sink bowl so held into a sander while improving worker safety. The Pollock '047 patent makes no provision for pivoting about a horizontal axis. The Jensen '618 and Handler '530 patents lack provision for advancing a workpiece with an arm. While the Hansen '605 patent does not grasp a workpiece. The Weissman '727 and Hennenfent '992 patents make no provision for a vertically oriented sander. The Day & McCandless '639 patent does not advance a valve stem into the grinder. Therefore, a need exists for a new and improved bowl sander that can operate a substantially vertical rotating disk. In this regard, the present invention substantially fulfills this need. In this respect, the bowl sander according to the present invention substantially departs from the conventional concepts and designs of the prior art, and in doing so provides an apparatus primarily developed for the purpose of operating a substantially vertical rotating disk.

### SUMMARY OF THE INVENTION

In view of the foregoing disadvantages inherent in the known types of sanders now present in the prior art, the present invention provides an improved bowl sander, and overcomes the above-mentioned disadvantages and drawbacks of the prior art. As such, the general purpose of the present invention, which will be described subsequently in greater detail, is to provide a new and improved bowl sander and method which has all the advantages of the prior art mentioned heretofore and many novel features that result in a bowl sander which is not anticipated, rendered obvious, suggested, or even implied by the prior art, either alone or in any combination thereof.

The present art overcomes the prior art limitations by holding a sink bowl upon an arm and then advancing the arm towards a substantially vertical sanding disk. A sink bowl has a substantially hemispherical shape with a perimeter flange. The flange joins to a countertop with an adhesive. Smooth flanges make a stronger joint between the flange and a countertop. To attain this, the present invention essentially comprises a disk with an abrasive, a flange, a motor, a gearbox, a frame, a spine, an arm and a holder. The disk has a generally round shape in a substantially vertical plane, a thickness sufficient to maintain rigidity of the disk, a first face and an opposite second face. The abrasive has sufficient roughness to abrade composite sink bowls and adheres to the first face of the disk. The flange has a centered collar perpendicular to the plate and joins to the second face of the disk. The motor drives a shaft for operating the bowl sander and has a distantly connected foot switch. Coaxial to the motor, the gearbox connects to the collar and reduces the rotation of the shaft to a desired rate. The substantially rigid frame supports the gearbox and the motor by a base, two legs, and a header. The spine extends perpendicular from the base and is generally centered upon the bowl sander. The arm has a socket and a pivoting connection to the spine opposite the base. The holder fits within the socket while the socket readily exchanges different forms of the holder. The holder supports a sink bowl for sanding by the bowl sander.

There has thus been outlined, rather broadly, the more important features of the invention in order that the detailed description thereof that follows may be better understood and in order that the present contribution to the art may be better appreciated.

The invention may also include a frame with braces, stiffeners, and a spine; an arm with a pin connecting to the spine; a holder with a stem, fingers, and stubs; fingers having an L or T shape; an abrasive of sandpaper or sand glued to the disk; and a socket that fits over the arm and the holder. Additional features of the invention will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and the scope of the present invention.

It is therefore an object of the present invention to provide a new and improved bowl sander that has all of the advantages of the prior art sanders and none of the disadvantages.

It is another object of the present invention to provide a new and improved bowl sander that may be easily and efficiently manufactured and marketed.

An even further object of the present invention is to provide a new and improved bowl sander that has a low cost of manufacture with regard to both materials and labor, and which accordingly is then susceptible of low prices of sale, thereby making such bowl sander economically available to the solid surface industry.

Still another object of the present invention is to provide a new bowl sander that provides in the apparatuses and methods of the prior art some of the advantages thereof, while simultaneously overcoming some of the disadvantages normally associated therewith.

Even still another object of the present invention is to provide a bowl sander with a substantially vertical rotating disk. This allows a smooth flange of a sink bowl in one step.

Still yet another object of the present invention is to provide a bowl sander with a substantially vertical rotating disk. This makes it possible to grasp sink bowls of various shapes.

Still yet another object of the present invention is to provide a bowl sander with a substantially vertical rotating disk. This makes it possible to improve worker safety.

Lastly, it is an object of the present invention to provide a new and improved method of sanding a sink bowl, the steps comprising: 1) assembling a frame proximate to a shop wall and floor; 2) attaching a motor and gearbox to the frame; 3) connecting an abrasive disk to the gear box; 4) placing an arm into a spine extending from the frame; 5) placing a holder into a socket on the arm opposite the spine; 6) positioning a sink bowl within the holder; 7) pushing the holder with the sink bowl towards the abrasive disk; 8) contacting the sink bowl upon the rotating abrasive disk until the flange of the sink bowl becomes smooth; 9) pulling the holder away from the abrasive disk; and, 10) removing the sink bowl from the holder.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows a side view of the preferred embodiment of the bowl sander in the first position and the second position, and constructed in accordance with the principles of the present invention.

FIG. 2 shows a front view of the bowl sander.

FIG. 3 shows a rear view of the bowl sander.

FIG. 4a shows a detailed front view of an alternate embodiment of the holder of the bowl sander. FIG. 4b shows a detailed front view of a further alternate embodiment of the holder. FIG. 4c shows a detailed front view of a still further alternate embodiment of the holder.

FIG. 5 shows an alternate embodiment of the bowl sander suitable for a dust collector.

The same reference numerals refer to the same parts throughout the various figures.

### DESCRIPTION OF THE PREFERRED EMBODIMENT

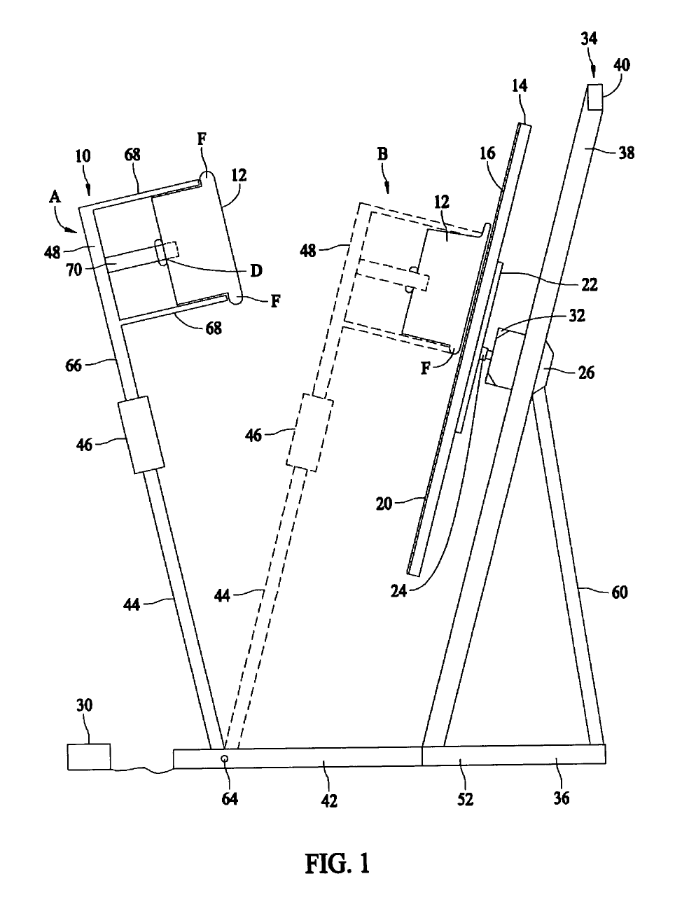

Referring now to the drawings, and particularly to FIGS. 1-5, a preferred embodiment of the bowl sander of the present invention is shown and generally designated by the reference numeral 10.

A sink bowl 12 has a substantially hemispherical shape with a perimeter flange F. The flange F joins to a countertop with an adhesive. Smooth flanges F make a stronger joint between the flange F and a countertop. The bowl sander 10 orients the sink bowl 12 so that the flanges F are substantially perpendicular to the plane defined by the surface of the earth, such as a floor. The present art holds a bowl upon an arm 44 and then advances the arm 44 towards a substantially vertical sanding disk 14.

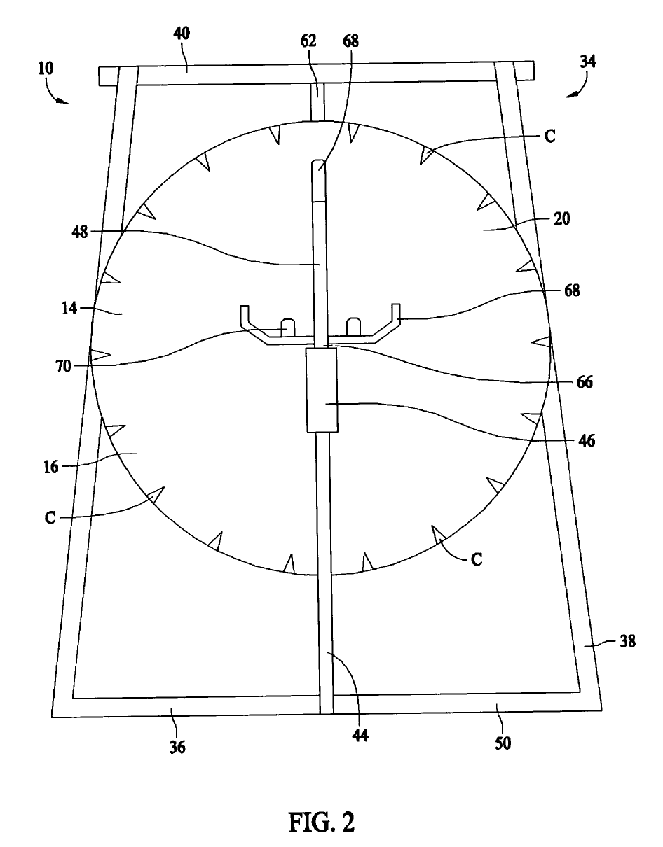

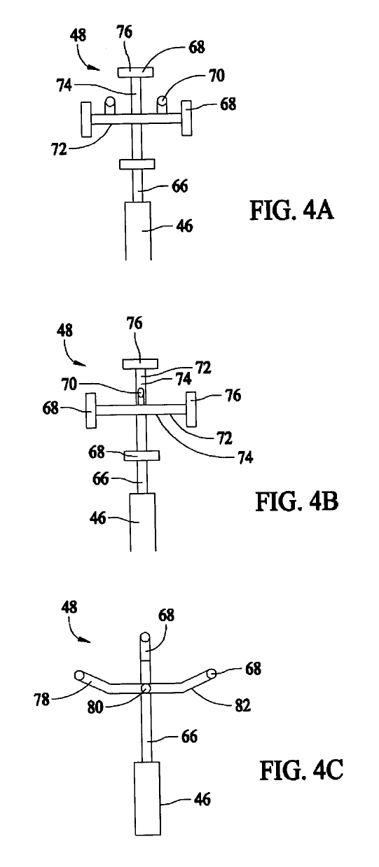

In FIG. 1, a new and improved bowl sander 10 of the present invention for substantially vertical rotating disk 14 is illustrated and will be described. A holder 48 with three or more fingers 68 and one or more stubs 70 maintains the position of the sink bowl 12. The holder 48 has alternate embodiments to hold sink bowls 12 of various shapes such as oval, rectangular, circular, single bowl, double bowl and the like as described in FIGS. 4a, 4b, & 4c. The fingers 68 support the rim of the sink bowl 12 and orient the flange F parallel to the sanding disk 14. The stubs 70 extend from the stem 66 or the interior of one or more fingers 68, fit into the drain hole D of a sink bowl 12, initially orient the sink bowl 12 in the holder 48, and then support the weight of the sink bowl 12 during operation of the invention. The fingers 68 join together at a stem 66 as shown in FIG. 2. A gap exists between the fingers 68 sized to admit a sink bowl 12. A worker may exchange the embodiments of the holder 48 for various shaped sink bowls 12. The arm 44 is parallel with the flange F of the sink bowl 12. The arm 44 has a first end with a socket 46 coaxial with the longitudinal axis of the arm 44, and a second opposite end with a hinge 64. The socket 46 receives the stem 66 of the holder 48.

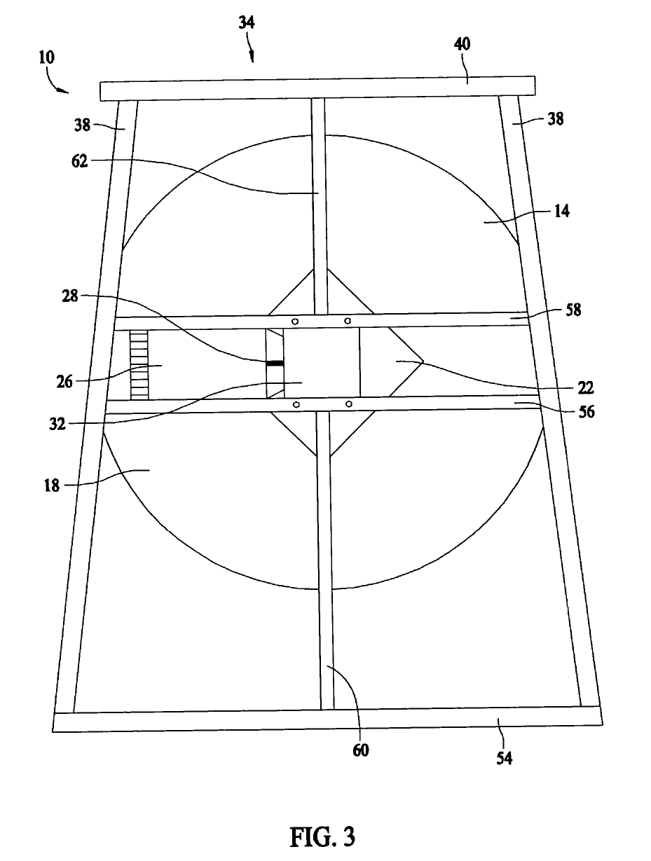

At the second end, the arm 44 pivotably connects to the spine 42. Pivotably means to allow rotation but not translation of a joint. The spine 42 traverses the floor perpendicular to the base 36. The spine 42 has a first end that connects to the arm 44 at the hinge 64 and an opposite second end. The second end of the spine 42 joins to the base 36, substantially at the center of the base 36. The base 36 attaches to the floor for the purpose of securing the bowl sander 10. The base 36 has one or more sides 52 connected into a polygonal shape defining a plane. In the preferred embodiment, the base 36 forms a rectangular shape. Where the spine 42 attaches is denoted the front 50 of the base 36. At each corner of the front 50 and a side 52, a leg 38 extends upward and away from the floor at a predetermined angle. The two legs 38 connect to the ends of a header 40. The header 40 attaches to a wall or other substantial object to secure the bowl sander 10. Opposite the front 50, the base 36 has a rear 54. Adjacent to the motor 26 and gearbox 32, one or more braces span between the legs 38 and support the combined gearbox 32 and motor 26 as shown in FIG. 3. The first brace 56 extends to both legs 38 and beneath the gearbox 32. The second brace 58 extends to both legs 38 and above the gearbox 32. The base 36, legs 38, header 40, and braces 56, 58 form a frame 34. Centered in the frame 34, a first stiffener 60 spans between the rear 54 of the base 36 and the first brace 56. A second stiffener 62 extends from the second brace 58 to the header 40 while centered in the frame 34. The first stiffener 60 and the second stiffener 62 stabilize the motor 26 and gearbox 32, and stiffen the frame 34.

In FIG. 3, the motor 26 acts in concert with a gearbox 32 that connects directly to the disk 14. The longitudinal axis of the motor 26 parallels the rear 54 side 52 of the base 36 while the longitudinal axis of the gearbox 32 parallels the spine 42. In an alternate embodiment, the longitudinal axes of the motor 26 and of the gearbox 32 are coaxial and parallel to the spine 42. Upon application of power to the motor 26, the motor 26 rotates a shaft 28 and through the gearbox 32, rotates the disk 14 at a predetermined rate of rotation. The substantially vertical disk 14 has an abrasive 20 affixed to its first face 16 suitable for sanding bowl flanges F, shown in FIG. 2 and a flange 22 affixed to its opposite second face 18 suitable for mounting the disk 14 to the gearbox 32, shown in FIGS. 1 & 3. Clamps C hold sandpaper upon the first face 16 as the abrasive 20. The first face 16 of the disk 14 is opposite the gearbox 32. A collar 24 extends perpendicular and centered upon the second face 18. The collar 24 joins to the gearbox 32. The disk 14 has a diameter substantially in excess of seven inches. Near the first end of the spine 42, the bowl sander 10 has a foot switch 30, shown in FIG. 1. The foot switch 30 controls delivery of power to the motor 26. Typically, the bowl sander 10 operates in a shop environment where the base 36 and the spine 42 attach to a floor. The rear 54 of the base 36 and the header 40 further attach to a wall.

Turning to FIGS. 4a, 4b, & 4c, the fingers 68 of the holder 48 support the rim of the sink bowl 12 and orient the flange F parallel to the sanding disk 14, see FIG. 1. The fingers 68 join together at a stem 66. In FIGS. 4a & 4b, the fingers 68 have an L shaped member 72 of two branches 74 and a cross member 76 where the cross member 76 attaches perpendicular to one branch 74 of the L shaped member 72 and the second branch 74 of the L shaped member 72 attaches to the stem 66. The fingers 68 with L shaped members 72 support either a square or double bowl sink. In FIG. 4c, the finger 68 has a T shaped member 78 where the vertical web 80 of the T shaped member 78 joins to the stem 66 and extends perpendicular from the stem 66 and the horizontal member 82 of the T shaped member 78 deflects. The fingers 68 with T shaped members 78 support an oval sink bowl 12.

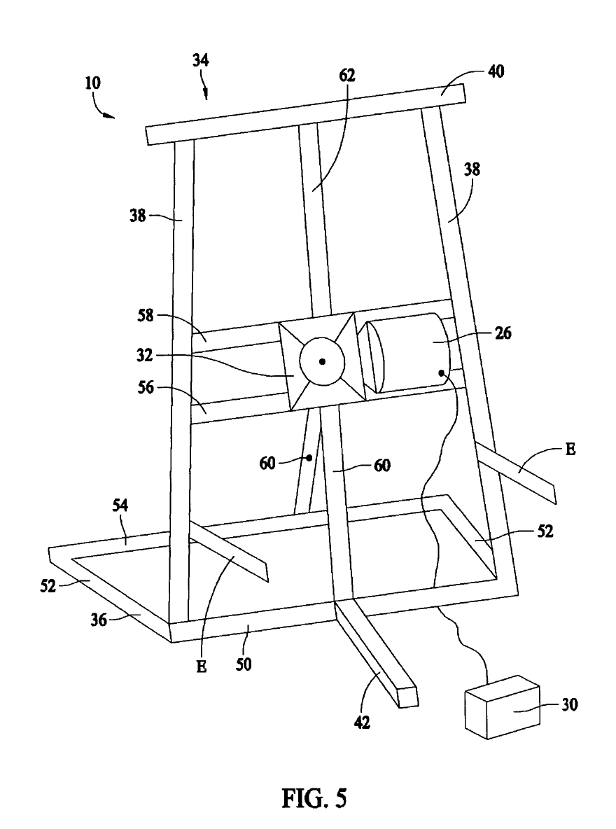

In FIG. 5, the present invention has the disk 14 omitted to reveal brackets E for a dust collector. The brackets E extend generally perpendicular to the legs 38 with one bracket E per leg 38. The brackets E extend parallel to the spine 42. A bin (not shown) rests upon the brackets E to collect dust from the disk 14 during operation. The bin covers at least the lower six inches of the disk 14. A vacuum system 66 (not shown) connects to the bin to evacuate the collected dust.

To utilize the present art, a worker assembles the invention upon a shop floor. The worker constructs the frame 34 by attaching the legs 38 to the header 40 and the front 50 of the base 36. The worker then installs the first brace 56 and second brace 58. The motor 26 connects to the gearbox 32. With the attached motor 26, the gearbox 32 bolts in front 50 of the first brace 56 and the second brace 58. With the gearbox 32 and motor 26 connected to the frame 34, the worker raises the frame 34 and secures it to a wall and the floor as shown in FIGS. 1 & 3. The worker completes the assembly of the base 36 and attaches the spine 42. Then, the worker connects the second end of the arm 44 to the spine 42 and installs one of a plurality of holders 48 into the socket 46. The bowl sander 10 takes the form shown in FIG. 2. The worker then connects the switch and power supply for the motor 26.

In operation, the worker places a sink bowl 12 upon the stubs 70 and within the fingers 68 of a holder 48, in the first position A a few degrees from perpendicular and away from the frame 34, as shown in FIG. 1. Pressing the foot switch 30, the worker activates the motor 26 and rotates the disk 14. Once the disk 14 rotates steadily, the worker pushes the arm 44 toward the disk 14 so that the flanges F of the sink bowl 12 contact the abrasive 20, in the second position B a few degrees from perpendicular and towards the frame 34, as shown in FIG. 1. Once the flanges F become smooth, the worker pulls the arm 44 back to the first position A. The worker then stops the motor 26 and removes the sink bowl 12 from the holder 48. The sink bowl 12 is now ready for the next step of production.

The preferred embodiment uses solid surface material for the sink bowl; tubular steel for the holder, the socket, and the arm; a steel pin for the hinge between the second end of the arm and the spine; a steel channel for the spine; steel angles of L shaped cross section for the base components, legs, header, first brace, second brace, first stiffener and second stiffener; an electrically powered motor; an electrical foot switch; a disk round in shape made of solid surface material bolted to the flange extending from a keyed collar; and sand paper clamped C to the disk as an abrasive. In the preferred embodiment, the steel parts are welded to form the frame. In an alternate embodiment, the motor is pneumatically powered. In a further alternate embodiment, the motor is hydraulically powered. In an alternate embodiment, the disk is plastic. In a further alternate embodiment, the disk is rubber. In a still further alternate embodiment, the disk is wood. In an alternate embodiment, the abrasive is sand adhered to the disk. In an alternate embodiment, the spine is a steel angle of L shaped cross section.

While a preferred embodiment of the bowl sander has been described in detail, it should be apparent that modifications and variations thereto are possible, all of which fall within the true spirit and scope of the invention. The bowl sander is uniquely capable of sanding the flanges of a sink bowl. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The bowl sander and its various components may be manufactured from many materials including but not limited to ferrous and non-ferrous metals and their alloys, plastics, and composites. Although sanding by a substantially vertical rotating disk has been described, it should be appreciated that the bowl sander herein described is also suitable for buffing surfaces of large objects. Furthermore, a wide variety of abrasives may be used instead of the sandpaper described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A bowl sander for preparing the flanges of sink bowls, comprising:
a disk having a generally round shape in a substantially vertical plane, a thickness sufficient to maintain rigidity of said disk, a first face and an opposite second face;
an abrasive having sufficient roughness to abrade composite sink bowls and adhering to said first face of said disk;
a flange having a centered collar perpendicular to said flange, said flange joins to said second face of said disk;
a motor driving a shaft for operating said bowl sander and a distantly connected foot switch;
a gearbox 32 connecting to said stem and reducing the rotation of said shaft to a desired rate;
a substantially rigid frame supporting said gearbox 32 and said motor having a base, two legs, and a header;
a spine extending perpendicular from said base, generally centered upon said bowl sander;
an arm having a socket, said arm pivotably connected to said spine opposite said base; and,
a holder releasably attached within said socket.

2. The bowl sander of claim 1 further comprising:
said frame having a base generally rectangular in shape formed by a front, two sides mutually parallel and perpendicular to said front, and a rear parallel to said front, said legs extending upwards from the corners formed by said front and said sides, said header parallel to said base and receiving said legs;
a first brace parallel to said front, attaching to said legs, and located beneath said gearbox 32 and said motor;
a second brace parallel to said front and to said first brace, attaching to said legs, and located above said gearbox 32 and said motor;
a first stiffener perpendicular to said base, extending from said rear of said base and joining said first brace proximate to the center of said first brace;
a second stiffener perpendicular to said base, extending from said second brace and joining said header proximate to the center of said header, and extending collinear with said first brace; and,
said spine extends perpendicular to said base from proximate to the center of said front and away from said frame, whereby said frame supports said bowl sander in cooperation with a wall and floor of a shop.

3. The bowl sander of claim 1 further comprising:
said arm joining to said spine by a hinge, said hinge allowing rotation of said arm towards and away from said disk, said hinge connects said arm to said spine opposite the joining of said spine to said base; and,
said socket extending coaxial from said arm opposite said hinge, having a width larger than said arm whereby said socket fits over said arm.

4. The bowl sander of claim 3 further comprising:
said holder having a stem, two or more fingers extending from said stem and grasping said sink bowl, and one or more stubs perpendicular to said fingers and said stubs snugly occupying the drain holes of said sink bowl whereby said fingers and said stubs orient the flange of said sink generally parallel to said disk.

5. The bowl sander of claim 4 wherein said stem of said holder fits snugly and releasably within said socket.

6. The bowl sander of claim 5 wherein said fingers have an L shaped member of two branches and a cross member, said cross member attaches perpendicular to one branch of said L shaped member and the second branch of said L shaped member attaches to said stem whereby said fingers support either a square or double bowl sink.

7. The bowl sander of claim 5 wherein a bent T shaped member forms said fingers, the vertical web of said T shaped member joins to said stem and the horizontal member of said T shaped member deflects forming said fingers whereby said fingers support an oval bowl sink.

8. The bowl sander of claim 1 wherein said abrasive is sandpaper attached to said disk by clamps.

9. The bowl sander of claim 1 wherein said abrasive is sand glued to said disk.

10. A bowl sander for preparing the flanges of sink bowls, comprising:
a motor rotating a shaft for operating said bowl sander and a distantly connected foot switch controlling said motor;
a gearbox connecting to said shaft and reducing the rotation of said shaft to a desired rate;
a flange having a centered collar perpendicular to said flange, said collar connects to said gearbox;
a disk having a generally round shape in a substantially vertical plane, a thickness sufficient to maintain rigidity of said disk, a first face and an opposite second face, said second face joins to said flange;
an abrasive having sufficient roughness to abrade composite sink bowls and adhering to said first face of said disk;
a frame supporting said gearbox and said motor having a base, two legs, and a header;
a spine extending perpendicular from said base, generally centered upon said bowl sander;
an arm having a socket, said arm pivotably connected to said spine opposite said base; and,
a holder releasably attached within said socket.

11. The bowl sander of claim 10 further comprising:
said frame having a base generally rectangular in shape formed by a front, two sides mutually parallel and perpendicular to said front, and a rear parallel to said front, two legs extending upwards from the corners formed by said front and said sides, a header parallel to said base and receiving said legs;
a first brace parallel to said front, attaching to said legs, and located beneath said gearbox and said motor;
a second brace parallel to said front and to said first brace, attaching to said legs, and located above said gearbox and said motor;
a first stiffener perpendicular to said base, extending from said rear of said base and joining said first brace proximate to the center of said first brace;
a second stiffener perpendicular to said base, extending from said second brace and joining said header proximate to the center of said header, and extending collinear with said first brace; and,
said spine extends perpendicular to said base from proximate to the center of said front and away from said frame, whereby said frame supports said bowl sander in cooperation with a wall and floor of a shop.

12. The bowl sander of claim 10 further comprising:
said socket having a width larger than said arm whereby said socket fits over said arm and opposite to said arm said socket accepts said holder; and,
said arm joining to said spine by a hinge, said hinge allowing rotation of said arm towards and away from said disk, said socket joins said arm opposite said hinge and said hinge connects said arm to said spine opposite the joining of said spine to said base.

13. The bowl sander of claim 12 further comprising:
said holder having a stem, two or more fingers extending from said stem and grasping said sink bowl, and one or more stubs perpendicular to said fingers and said stubs snugly occupying the drain holes of said sink bowl whereby said fingers and said stubs orient the flange of said sink bowl generally parallel to said disk.

14. The bowl sander of claim 13 wherein said stem of said holder fits snugly and releasably within said socket.

15. The bowl sander of claim 14 wherein said fingers have an L shaped member of two branches and a cross member, said cross member attaches perpendicular to one branch of said L shaped member and the other branch of said L shaped member attaches to said stem whereby said fingers support either a single or double sink bowl.

16. The bowl sander of claim 14 wherein a bent T shaped member forms said fingers, the vertical web of said T shaped member joins to said stem and the horizontal member of said T shaped member deflects forming said fingers whereby said fingers support an oval sink bowl.

17. The bowl sander of claim 10 wherein said abrasive is sandpaper attached to said disk by clamps.

18. The bowl sander of claim 10 wherein said disk has a diameter in excess of the width of a double sink bowl.

19. A method of sanding a sink bowl, the steps comprising:
1) assembling a frame proximate to a shop wall and floor; and,
2) attaching a motor and a gearbox to said frame; and,
3) connecting an abrasive disk to said gear box; and,
4) placing an arm into a spine extending from said frame; and,
5) placing a holder into a socket on said arm opposite said spine; and,
6) positioning a sink bowl within said holder; and,
7) pushing said holder with said sink bowl towards said abrasive disk; and,
8) contacting said sink bowl with said abrasive disk while rotating until a flange of said sink bowl becomes smooth; and,
9) pulling said holder away from said abrasive disk; and,
10) removing said sink bowl from said holder.

20. The method of sanding a sink bowl in claim 19 further comprising:
said abrasive disk having sandpaper clamped upon said abrasive disk.
